(19) United States
(12) Patent Application Publication
(10) Pub. No.: US 2006/0256553 A1
(43) Pub. Date: Nov. 16, 2006

(54) Combination flashlight

(76) Inventor: Ning-guo Lin, Orange, CA (US)

Correspondence Address: YING CHEN, 255 S. GRAND AVE., # 215, LOS ANGELES, CA, 90012, US

(21) Appl. No.: 11/130,795

(22) Filed: May 16, 2005

(51) Int. Cl. F21L 4/02

(52) U.S. Cl. 362/184

(57) ABSTRACT

A flashlight having a number of unique and advantageous features is disclosed. The flashlight has two light sources, such as a xenon light bulb and a plurality of light-emitting diodes (LEDs). A switch and a switching circuit function to turn the two light sources on and off in one of four states: (1) both light sources are off, (2) only the first light source is on, (3) only the second light source is on, and (4) both light sources are on. The flashlight has an end portion having a substantially cylindrical shape with a plurality of parallel grooves, which are useful for stopping a rolling movement of the flashlight when it is laid on its side. The flashlight body has an indented portion for receiving the switch, the indented portion having a cylindrical shape that can be machined relatively easily.

### BACKGROUND OF THE INVENTION

This invention relates to a flashlight, and in particular, to a combination flashlight having two types of light sources such as a xenon bulb and LEDs (light-emitting diodes).

### SUMMARY OF THE INVENTION

The present invention is directed to a flashlight having a number of unique and advantageous features.

One feature of the flashlight is that two (first and second) light sources are provided within the head portion of the flashlight. A switch is provided on the body, and a switching circuit is disposed within the flashlight and connected to the switch. The switching circuit has four on/off states including a first state where both the first and second light sources are off; a second state where only the first light source is on, a third state where only the second light source is on, and a fourth state where both the first and second light sources are on. The first light source is a xenon light bulb and the second light source is a plurality of light-emitting diodes (LEDs).

Another feature of the flashlight is an end portion thereof that has a substantially cylindrical shape and defines a plurality of grooves parallel to a longitudinal axis of the flashlight body. A useful function of the grooves is to stop a rolling movement of the flashlight when it is laid on its side.

Yet another feature of the flashlight is an indented portion defined on the body for receiving a switch, where the bottom surface of the indented portion is a part of a cylindrical surface. An advantage of using a cylindrical surface is that the indented portion can be machined in relatively simple steps. A through hole is defined in the flashlight body at center of the indented portion through which the switch passes into the interior of the flashlight,

It is to be understood that both the foregoing general description and the following detailed description are exemplary and explanatory and are intended to provide further explanation of the invention as claimed.

### BRIEF DESCRIPTION OF THE DRAWINGS

FIG. 1 is a perspective view of a flashlight according to an embodiment of the present invention.

FIG. 2 depicts the head portion of the flashlight of FIG. 1.

FIG. 3 depicts the end portion of the flashlight of FIG. 1.

FIG. 4 depicts a portion of the body of the flashlight of FIG. 1 and switch.

FIG. 5 schematically illustrates a switching circuit of the flashlight of FIG. 1.

### DETAILED DESCRIPTION OF THE PREFERRED EMBODIMENTS

The present invention provides a flashlight having several unique and advantageous features.

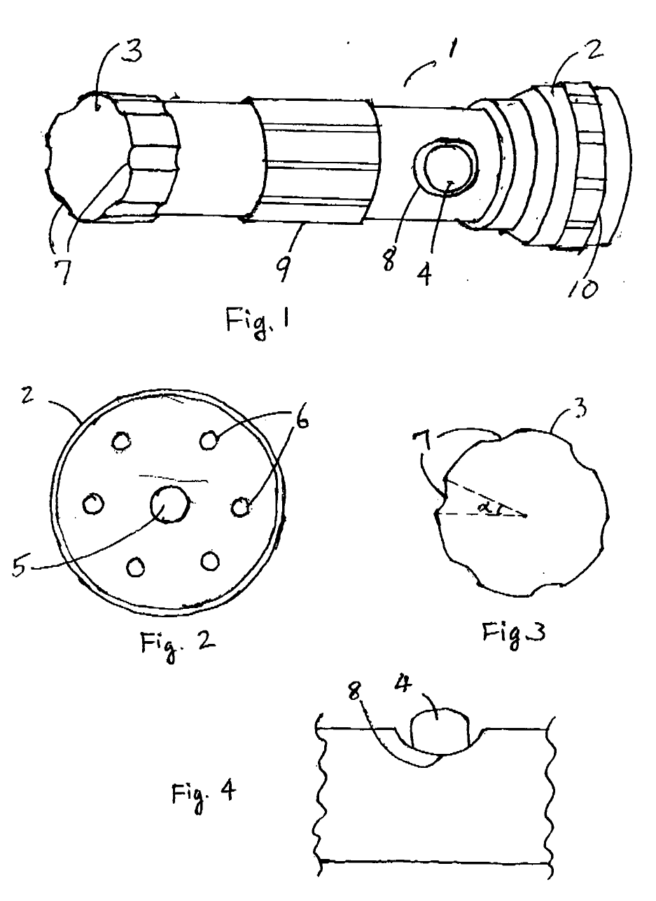

FIG. 1 is a perspective view of a flashlight according to embodiments of the present invention. The flashlight 1 has a head portion 2 and an end portion 3, and a switch 4 provided on the substantially cylindrical body of the flashlight. The body is preferably made of a metal such as aluminum. As shown in FIG. 2, which is viewed along a longitudinal axis defined by the body of the flashlight from the head 2, disposed with the head portion 1 are two light sources: At the center is a first light source 5, which includes a xenon bulb or a tungsten incandescent bulb; around the peripheral are a second light source 6, which includes a plurality of LEDs (light-emitting diodes). Preferably, the LEDs are disposed at equal distance from each other along the peripheral. One advantageous feature of the flashlight according to an embodiment of the present invention is toggle switch 4 and an electrical circuit 11 (see FIG. 5) inside the flashlight that function to alternatively turn on and off the first and second light sources. The switch circuit 11 has four on/off states of providing power to the first and second light sources: (1) both first and second light sources are off (i.e. no electricity is provided to the respective light source from a power source such as batteries); (2) only the first light source is on (i.e. electricity is provided to that light source when a power source such as batteries is present in the flashlight); (3) only the second light source is on; and (4) both the first and second light sources are on. When the switch 4 is repeatedly pressed, the flashlight goes through the above four on/off states successively. The flashlight can be designed to go through the four states in any desired order.

FIG. 5 is a diagram schematically illustrating the switch circuit 11 coupled to the switch 4 and the first and second light sources.

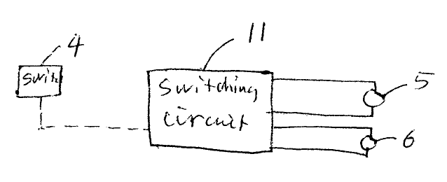

Another advantageous feature of a flashlight according to an embodiment of the present invention is the shape of the end portion 2. As shown in FIG. 1 and FIG. 3, which is viewed along the longitudinal axis of the flashlight from the end 3, the end portion is substantially cylindrical in shape, and has a plurality of grooves 7 defined on its circumference. The grooves 7 are parallel to the longitudinal axis of the flashlight body, and the bottom surface of the grooves is preferably a part of a cylindrical surface, although other shapes (such as a triangle) are also possible. Using a cylindrical surface enables the grooves to be formed by relatively simple machining steps. The grooves preferably have equal width; and the width, as defined by the angle α spanned by the two parallel edges of a groove, as shown in FIG. 3, is preferably between 20 and 30 degrees, but other widths are also possible. A useful function of the grooves is to stop a rolling movement of the flashlight when it is laid on its side and when the end portion 3 contacts the surface on which the flashlight is laid. The wider the grooves, generally the better their ability to stop a rolling movement, but overly wide grooves may affect the aesthetics of the flashlight product. The number of grooves shown in FIGS. 1 and 3 is six, although other numbers are also possible.

Another advantageous feature of a flashlight according to an embodiment of the present invention is the shape of an indented portion 8 on the body that receives the switch 4. FIG. 4 illustrates a portion of the body viewed in a direction perpendicular to the longitudinal axis, showing the indented portion 8. The shape of the bottom surface of indented portion 8 is a part of a cylindrical surface, the axis of the cylinder being perpendicular to the longitudinal axis of the flashlight body. An advantage of using a cylindrical surface (as opposed to a surface that has curvatures in both direction, as used in some conventional flashlight designs) is that the indented portion can be machined in relatively simple steps. A through hole is defined in the flashlight body at center of the indented portion, through which the switch 4 passes into the interior of the flashlight and is connected to the circuit shown in FIG. 5.

Other useful design features may also be provided for a flashlight. As shown in FIG. 1, a sleeve 9 made of a non-slick material such as rubber may be provided on a middle section of the flashlight body to help a user to securely hold the flashlight. The body may be slightly indented to receive the sleeve. Another sleeve 10 made of a non-slick material such as rubber may be provided around a section of the head portion 2 to facilitate rotation of the head section by a user during a focusing operation.

A flashlight according to embodiments of the present invention may have any one of the above-described advantageous features or any combination thereof. It will be apparent to those skilled in the art that various modification and variations can be made in the flashlight of the present invention without departing from the spirit or scope of the invention. Thus, it is intended that the present invention cover modifications and variations that come within the scope of the appended claims and their equivalents.

What is claimed is:

1. A flashlight comprising:
a body;
a head portion;
a first and a second light source disposed within the head portion;
a switch provided on the body; and
a switching circuit disposed within the flashlight and connected to the switch, the switching circuit having four on/off states including a first state where both the first and second light sources are off, a second state where only the first light source is on, a third state where only the second light source is on, and a fourth state where both the first and second light sources are on.

2. The flashlight of claim 1, wherein the first light source is a xenon light bulb and the second light source is a plurality of light-emitting diodes (LEDs).

3. The flashlight of claim 2, wherein the xenon light bulb is disposed near a center of the head portion and the plurality of LEDs are disposed around a peripheral of the head portion.

4. The flashlight of claim 1, wherein the switch is connected to the switching circuit to change the switching circuit from one on/off state to another on/off state when the switch is depressed.

5. A flashlight comprising a body and an end portion, wherein the end portion has a substantially cylindrical shape and defines a plurality of grooves parallel to a longitudinal axis of the body.

6. The flashlight of claim 5, wherein a width of each groove is between 20 and 30 degrees.

7. The flashlight of claim 5, wherein the bottom surface of the grooves is a part of a cylindrical surface.

8. A flashlight comprising a body and a switch provided on the body, the body defining an indented portion, the bottom surface of the indented portion being a part of a cylindrical surface which defines an axis perpendicular to a longitudinal surface defined by the body.

9. The flashlight of claim 1, wherein the body defines a through hole within the indented portion, and wherein the switch is received in the through hole.
